(19) United States
(12) Patent Application Publication
(10) Pub. No.: US 2006/0185926 A1
(43) Pub. Date: Aug. 24, 2006

(54) Front to rear steering system mechanical linkage assembly

(76) Inventors: Andre-Marie Simard, Baie-Saint-Paul (CA); Rejean Lavoie, Baie-Saint-Paul (CA)

Correspondence Address: FOGG AND ASSOCIATES, LLC, P.O. BOX 581339, MINNEAPOLIS, MN, 55458-1339, US

(21) Appl. No.: 11/351,197

(22) Filed: Feb. 9, 2006

Related U.S. Application Data
(60) Provisional application No. 60/651,066, filed on Feb. 9, 2005.

(51) Int. Cl. B62D 7/15; B62D 13/00

(52) U.S. Cl. 180/409; 280/419; 180/414

(57) ABSTRACT

A mechanical linkage assembly for a multiple-axle vehicle is provided, this vehicle having both front and rear wheels steering systems. The linkage assembly includes a front linkage gear mechanism connected to the front steering system and transforming the steering movement therefrom into a rotation movement, and a rear linkage gear mechanism connected to the rear steering system and transforming this rotation movement into a rear wheels steering movement. A shaft or other connecting component connects the front and rear linkage gears mechanism to transmit the rotation movement therebetween. Independent hydraulic control of the front and rear steering gears may also advantageously be provided.

### FIELD OF THE INVENTION

The present invention relates to the field of steering systems for vehicles, such as for example heavy weight trucks, and more particularly concerns a mechanical linkage assembly for operationally connecting steerable rear wheels of such a vehicle with the steering system of the front wheels.

### BACKGROUND OF THE INVENTION

Trucks having steerable rear wheels are already known in the art. The steering system of the rear wheels is generally either independent from the steering system of the front wheels, or is controlled through an electronic circuit responsive to the steering action exerted on the steering system of the front wheels. Both of these approaches have inherent drawbacks, as independent systems require two human operators, and electronic controlled systems are subject to failures and safety concerns. It would therefore be advantageous to devise a system providing a mechanical connection linking the steering of the rear wheels to that of the front wheels.

Known in the art of mechanical linkage between the front and rear steering systems of a multi-wheel vehicle is a recently developed set-up as shown in FIGS. 1A and 1B (PRIOR ART). In this design, the vehicle is provided with both a front and a rear steering systems 20 and 22, including a combination of steering gear boxes and tie rods as are well known in the art. As illustrated, the vehicle includes seven axles, the first three and last two being directional. The front and rear steering systems 20 and 22 are connected together by a succession of tie rods 24, 24′ and 24″. In the illustrated design, a first tie rod 24 is connected to the front steering system 20 through a pivot 26, which inverses the steering direction so that the rear wheels turn in a direction opposite that of the front wheels. Two additional tie rods 24′ and 24″ are provided and the resulting three such rods 24, 24′ and 24″ are interconnected by additional pivots 26′ and 26″. The final tie rod 24″ is connected to the pitman arm 30 of an assisted steering box 28 of the rear steering system 22.

Although the above described system provides for the mechanical linkage of the front and rear steering systems, it has several drawbacks which make it impracticable. Additionally, an issue with this system is the inadequacy of the hydraulic system providing hydraulic pressure to all of the steering gears on the vehicle, both at the front and back, to take into account the load on the rear axles, and therefore correctly adjust pressure to the steering gears of the rear steering system.

There is therefore a need for an improved mechanical linkage assembly between the front and rear steering systems of a multi-axle vehicle.

### SUMMARY OF THE INVENTION

According to a first aspect of the present invention, there is provided a mechanical linkage assembly for a multiple-axle vehicle having a front and rear steering system which respectively steer the front and rear wheels of the vehicle. The front steering system is responsive to a steering signal from an operator of the vehicle.

The mechanical linkage assembly first includes a front linkage gear mechanism having a rotatable shaft and a pivotable arm operationally connected to the front steering system for receiving the steering signal therefrom. The front linkage gear mechanism also includes a gear arrangement transforming a pivoting of the pivotable arm into a rotation of the rotatable shaft.

A rear linkage gear mechanism is also provided, and has a rotatable shaft, a pivotable arm operationally connected to the rear steering system for transmitting the steering signal thereto and a gear arrangement transforming a rotation of the rotatable shaft into a pivoting of the pivotable arm.

The mechanical linkage assembly finally includes mechanical connecting means operationally connecting the rotatable shafts of the front and rear linkage gear mechanisms.

According to another aspect of the present invention, there is also provided a steering arrangement for jointly steering front and rear wheels of a multiple-axle vehicle. The steering arrangement includes a front steering system steering the front wheels of the vehicle and responsive to a steering signal from an operator of the vehicle. A mechanical linkage assembly is further provided, and includes:
a front linkage gear mechanism having a rotatable shaft, a pivotable arm operationally connected to the front steering system for receiving the steering signal therefrom, and a gear arrangement transforming a pivoting of the pivotable arm into a rotation of the rotatable shaft;
a rear linkage gear mechanism having a rotatable shaft, a pivotable arm and a gear arrangement transforming a rotation of the rotatable shaft into a pivoting of the pivotable arm,; and
mechanical connecting means operationally connecting the rotatable shafts of the front and rear gear mechanisms;

The steering arrangement also includes a rear system steering the rear wheels of the vehicle. The rear steering system is connected to the pivotable arm of the rear linkage gear mechanism for receiving the steering signal therefrom.

According to a preferred embodiment of the invention, the steering arrangement above further includes a front hydraulic pressure system responsive to a load on the front wheels of the vehicle. The front hydraulic pressure system provides a hydraulic pressure signal to both the front steering system of the vehicle and the front linkage gear mechanism of the mechanical linkage assembly. A rear hydraulic pressure system responsive to a load on the rear wheels of the vehicle is also preferably provided. The rear hydraulic pressure system provides a hydraulic pressure signal to the rear steering system of the vehicle and to the rear linkage gear mechanism of the mechanical linkage assembly.

According to yet another aspect of the present invention there is also provided a method for providing a multiple-axle vehicle with joint steering of front and rear wheels thereof. The vehicle has a front steering system steering the front wheels and responsive to a steering signal from an operator of the vehicle. The method includes the following steps of:

a) providing the vehicle with a rear steering system steering the rear wheels of the vehicle;

b) providing the vehicle with a mechanical linkage assembly comprising:
a front linkage gear mechanism having a rotatable shaft, a pivotable arm, and a gear arrangement transforming a pivoting of the pivotable arm into a rotation of the rotatable shaft;
a rear linkage gear mechanism having a rotatable shaft, a pivotable arm, and a gear arrangement transforming a rotation of the rotatable shaft into a pivoting of the pivotable arm; and
mechanical connecting means operationally connecting the rotatable shafts of the front and rear linkage gear mechanisms;

c) operationally connecting the pivotable arm of the front linkage gear mechanism to the front steering system for receiving the steering signal therefrom; and

d) operationally connecting the pivotable arm of the rear linkage gear mechanism to the rear steering system for transmitting the steering signal thereto.

Other features and advantages of the present invention will be better understood upon reading of preferred embodiments thereof with reference to the appended drawings.

### BRIEF DESCRIPTION OF THE DRAWINGS

FIGS. 1A and 1B (PRIOR ART) are side views from the right of the front and rear of a vehicle provided with a steering system in accordance with prior art.

FIG. 2A is a side view from the left of a vehicle provided with a steering system in accordance with an embodiment of the present invention; FIG. 2B is a side view from the right of the vehicle of FIG. 2A.

FIG. 3 is a side view from the left of the front of a vehicle of FIGS. 2A and 2B.

FIG. 4 is a side view from the left of the rear of the vehicle of FIGS. 2A and 2B.

FIG. 5 is a side view from the right of the rear of the vehicle of FIGS. 2A and 2B.

FIG. 6 is a side view from the right of the front of the vehicle of FIGS. 2A and 2B.

FIG. 7 is a schematized top view of a vehicle provided with a steering system according to an embodiment of the present invention.

FIG. 8 is a diagram of a hydraulic system for use with the present invention.

FIG. 9 is a cross-sectional view of a steering gear for use as a front linkage gear mechanism according to an embodiment of the present invention.

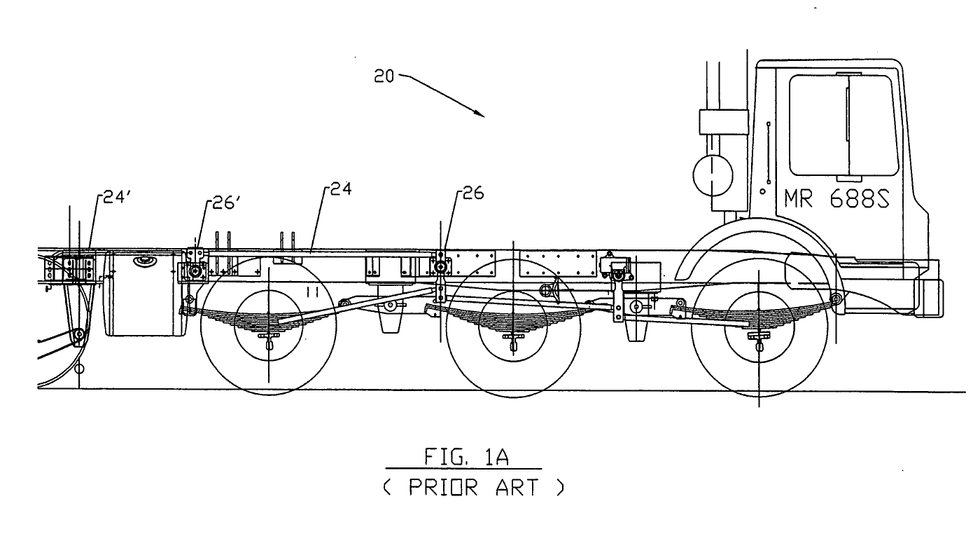

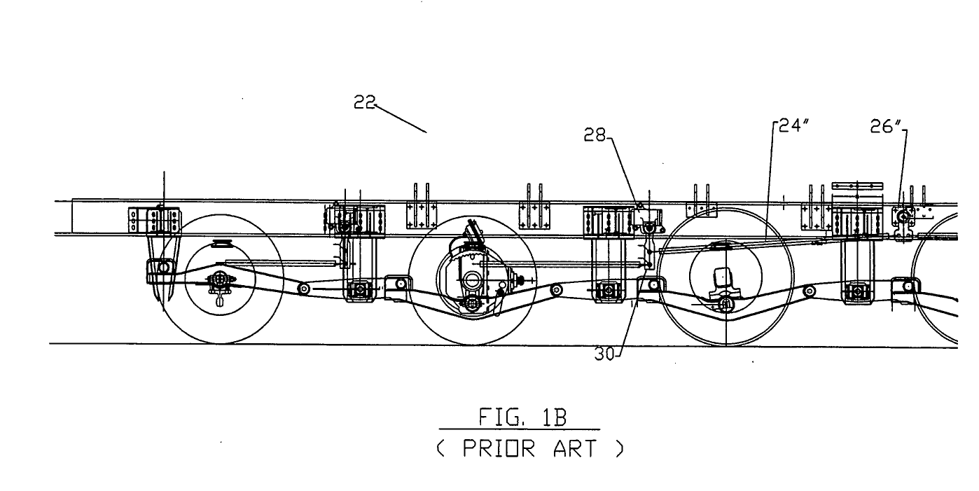

### DESCRIPTION OF A PREFERRED EMBODIMENT OF THE INVENTION

The present invention relates to steering systems for multiple-axle vehicles. It is understood that the present invention can be used on any vehicle where there is a need to provide a steering system to the rear axles or adapt a pre-existing rear steering system. The vehicle may or may not have fixed non-steerable axles between the front and rear directional ones or anywhere else. In addition, the expressions “front” and “rear” are understood herein to refer to the relative positions of components with respect to each other; for example, the rear axles may be located at a forward location on the vehicle, as long as they are behind the front axles. Each axle may support single or double wheels on each side, or more, as required by the general design of the vehicle.

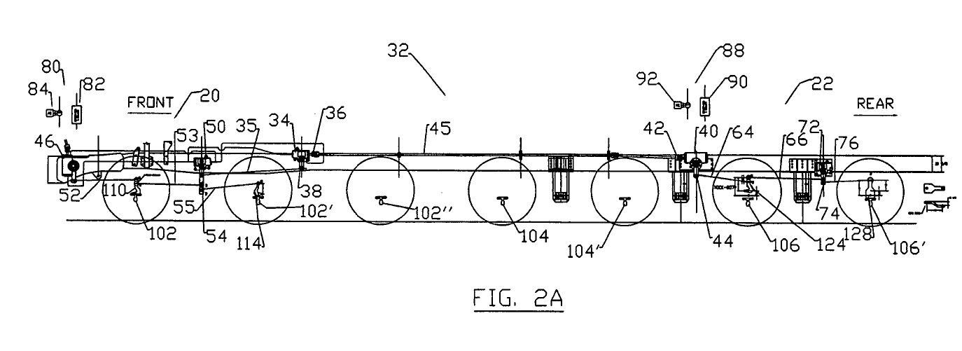

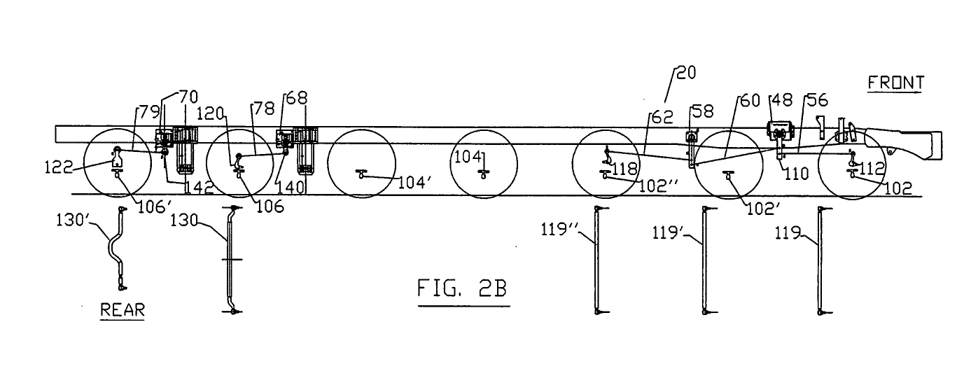

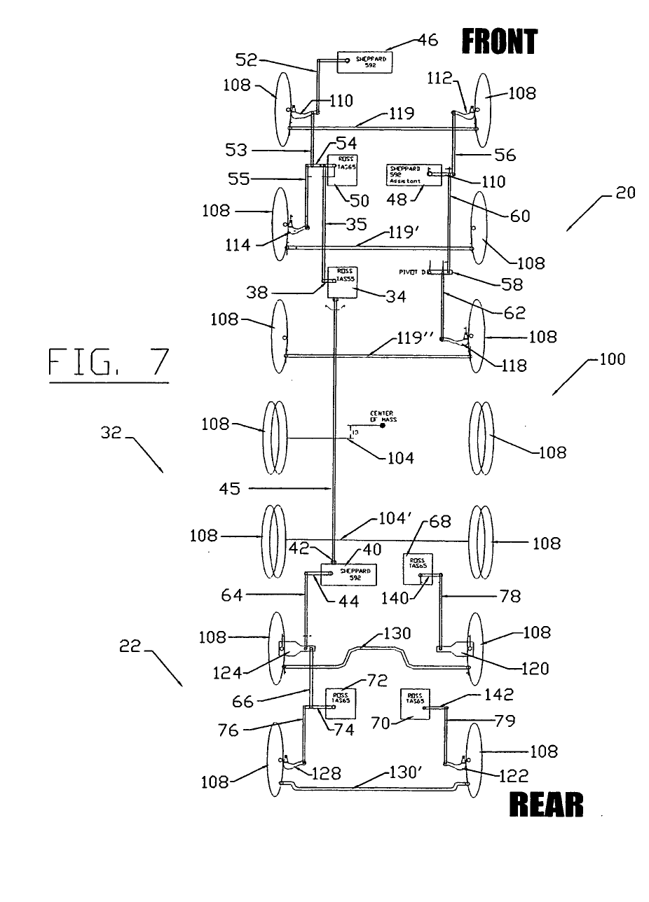

According to a first aspect of the present invention, a mechanical linkage assembly 32 operationally connecting the front and rear steering systems 20 and 22 of such a vehicle is provided. Such an assembly is best seen with reference to FIGS. 2A, 2B and 7.

The assembly first includes a front linkage gear mechanism 34, which has a rotatable shaft 36 and a pivotable arm 38. The pivotable arm 38 is operationally connected to the front steering system 20 as will be explained in further details below. The front linkage gear mechanism also includes a gear arrangement which may be embodied by any component or ensemble of components allowing transforming a pivoting movement of the pivotable arm into a rotation movement of the rotational shaft. A gear box having an appropriate gear ratio could for example be used, or a combination of gear boxes. In the preferred embodiment, the gear mechanism 34 is embodied by a steering gear having a steering gear shaft embodying the rotatable shaft 36, and a pitman arm embodying the pivoting arm 38.

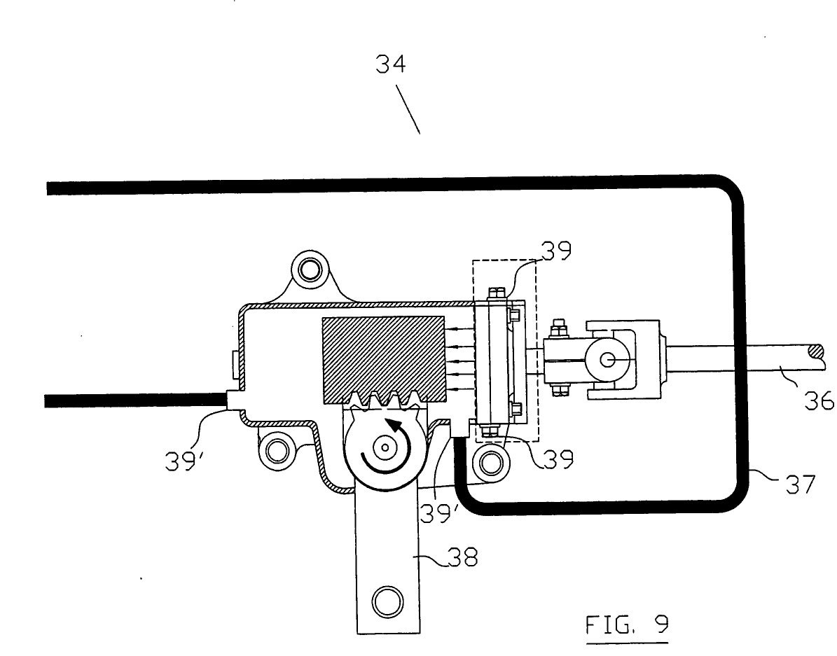

Steering gears in general are usually provided with a hydraulic power flow designed to assist the pivoting movement of its pitman arm when its steering shaft is rotated. The steering gear embodying the gear mechanism 34 preferably operates “in reverse” of its usual functions and is provided with a hydraulic flow assisting the rotation of its shaft when its pitman arm is pivoted. The front linkage steering gear 34 in effect acts as a motor. Referring to FIG. 9, in one embodiment of the invention, a regular steering gear is preferably modified to become a “steering gear assist” (embodying the front linkage gear mechanism 34) in the following manner. First, the channels 39 for the hydraulic power flow which assist the pivoting movement of the pitman arm 38 when the steering shaft 36 is rotated are blocked up. Then, new channels 39′ for the hydraulic power flow 37 have been machined into the steering gear in order to assist the rotation of the steering shaft 36 when there is a pivoting movement of the pitman arm 38. In this manner, instead of being a steering gear in which the rotation of the steering shaft drives a hydraulically assisted pivoting movement of the pitman arm, it is now a “steering gear assist” in which a pivoting movement of the pitman arm drives a hydraulically assisted steering shaft rotation. A standard steering box can easily be modified by one skilled in the art to achieve this result, or an already inversed steering box could be custom made for use with the present invention.

Referring back to FIGS. 2A, 2B and 7, at the rear of the vehicle, there is provided a rear linkage gear mechanism 40 also having a rotatable shaft 42 and a pivotable arm 44. The pivotable arm 44 is operationally connected to the rear steering system 22 to provide the steering signal thereto. The rear linkage gear mechanism is preferably embodied by a steering gear having a steering shaft 40 embodying the rotatable shaft and a pitman arm 44 embodying the pivotable arm. In the preferred embodiment, the rear linkage gear mechanism 40 is in effect part of the rear steering system 22 as it acts as its primary gear box.

The shafts 36 and 42 of the front and rear gear mechanisms 34 and 40 are operationally connected so that the rotation movement of the first is transmitted to the second. Preferably, a connecting shaft 45 is provided for this purpose, extending longitudinally along the vehicle and having opposite ends coaxially connected to the rotatable shafts 36 and 42 through any appropriate means. The connecting shaft 45 may for example be made of cold drawn steel or any other suitable material.

As will be clear to one skilled in the art, the connecting shaft 45 may be alternatively replaced by any component or combination of components apt to make the required operational connection between the front and rear linkage gear mechanisms. For example, a cable of appropriate rigidity may be used. In another embodiment, the connection may be made through a combination of interconnected mechanical components such as rods, shafts, cables or the like. It is also understood that the connection between the rotatable shafts of the rear and front linkage gear mechanisms need not be strictly rectilinear, and that the rotatable shafts need not be in alignment. It is sufficient for the purposes of the present invention that the rotational movement of the rotatable shaft of the front linkage gear mechanism be properly transferred to the rotatable shaft of the rear linkage gear mechanism.

As one skilled in the art will readily understand, the linkage assembly according to the present invention provides for the purely mechanical transfer of the steering signal from the front to the rear of the vehicle. In the preferred embodiment, both the front and rear linkage steering gears are located on the left side of the vehicle, but they could of course be positioned anywhere else.

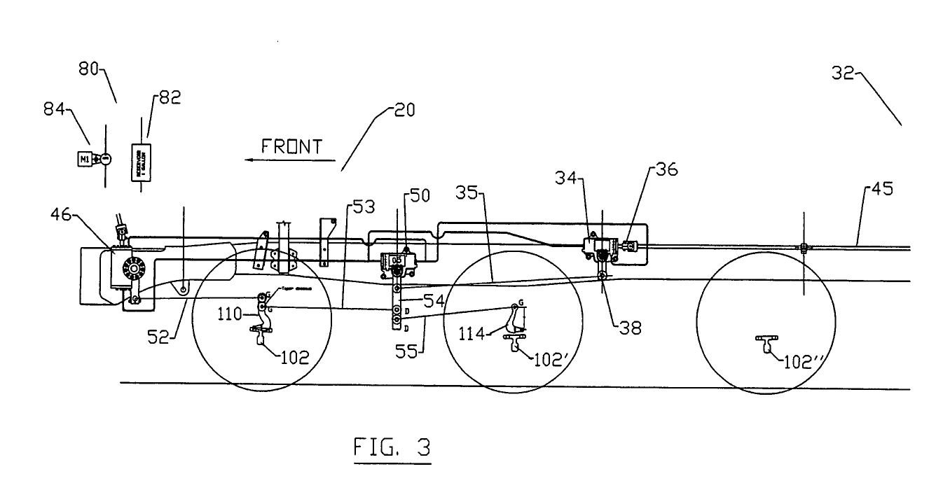

According to another aspect of the invention, there is provided a steering arrangement including a front steering system and a rear steering system joined by a mechanical linkage assembly as described above. With reference to FIGS. 3, 6 and 7, an exemplary embodiment of such a front steering system 20 will now be described. It is however understood that the particular characteristics of this steering system is in no way limitative to the present invention.

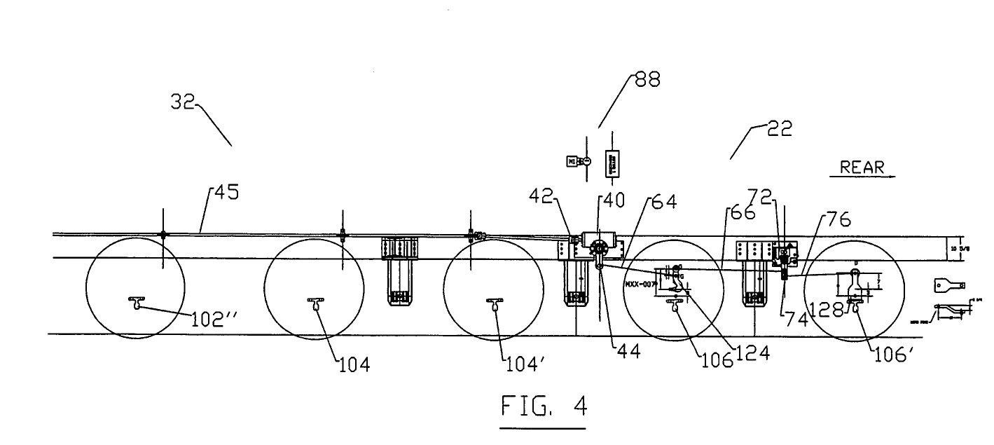

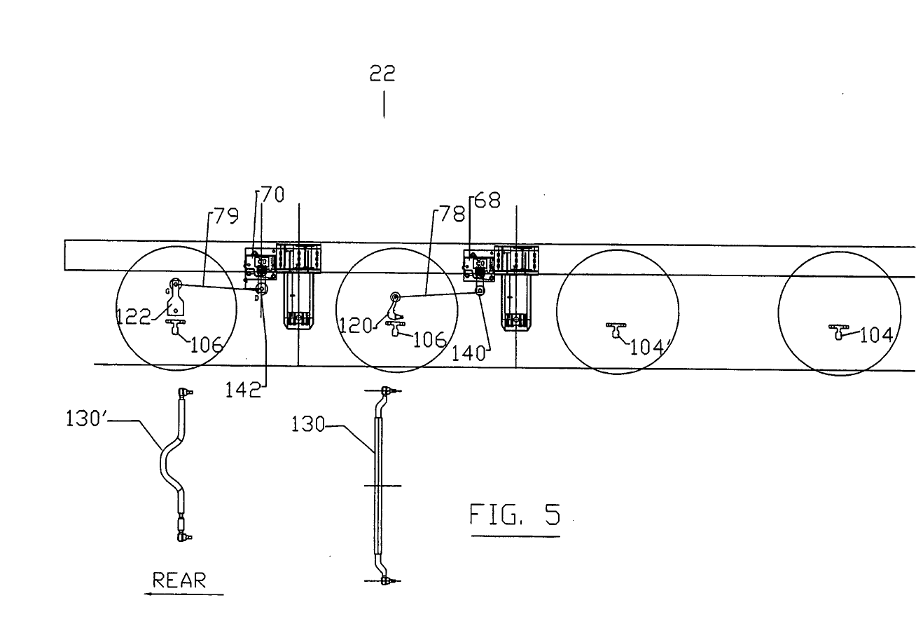

In the illustrated embodiment, the invention is applied to a truck 100 having three steerable front axles 102, 102′ and 102″, two fixed middle axles 104 and 104′ and two steerable rear axles 106 and 106′ (shown in FIGS. 4 and 5). A wheel 108 is mounted at each extremity of each steerable axle, and pairs of wheels 108 are mounted on each side of the fixed middle axles. The orientation of the steerable front axles 102, 102′ and 102″ is controlled by the front steering system 20, which is of a generally traditional construction. It includes a main front steering box 46 and right and left side assistant boxes 48 and 50 which, through a suitable arrangement of arms, links and tubes, operate to steer the front wheels of the truck.

In the preferred embodiment, on the left side of the truck 100 (see FIG. 3), the main steering box 46 is connected by a tie rod 52 to the left steering arm 110 of the first front axle 102. In turn, this steering arm 110 is linked through another tie rod 53 to the pitman arm 54 of a left side assistant box 50, which is itself connected to the left steering arm 114 of the second front axle 102′ through a tie rod 55.

As illustrated, the front steering system 20 is connected to the mechanical linkage assembly 32 through a tie rod 35 linking the pitman arm 54 of the left assistant steering box 50 to the pivotable arm 38 of the front linkage gear mechanism 34.

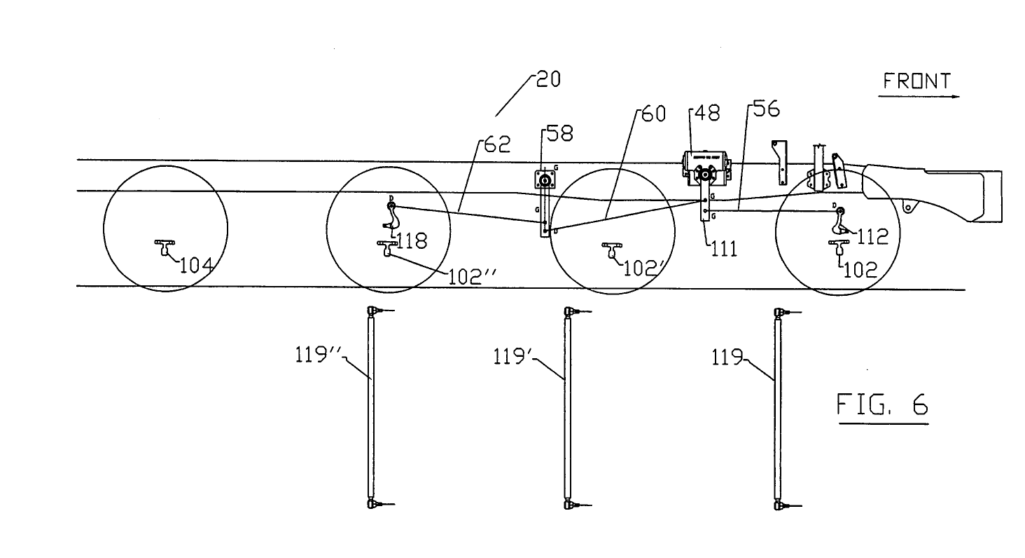

On the right side of the truck 100 (see FIG. 6), the movement of the steering wheel is transmitted through the right steering arm 112 of the first front axle 102 to the pitman arm 111 of the right side assistant gearbox 48 through tie rod 56. A pivot 58 is provided and linked to the right side assistant box 48 and to the right steering arm 118 of the third front axle 102″ by tie rods 60 and 62, respectively. Transversal tie rods 119, 119′ and 119″ are provided to connect the idle arms on opposite sides of axles 102, 102′ and 102″, respectively.

Referring to FIGS. 4, 5 and 7, it can be seen that a similar steering system 22 is also arranged for steering the rear wheels of the vehicle. It preferably includes the rear linkage gear mechanism 40, first and second rear right side assistant steering boxes 68 and 70 and a rear left side assistant steering box 72. The rear steering system 22 may already be present on a given vehicle 100 or be installed at the same time as the linkage assembly 32 of the present invention.

In the illustrated embodiment, the steering signal is received from the connecting shaft 45 on the left side of the rear steering system (see FIG. 4) by the rear linkage gear mechanism, here embodied by a steering gear 40. Its pitman arm 44 is connected to the left steering arm 124 of the first rear axle 106 by tie rod 64. Another tie rod 66 links this left steering arm 124 to the pitman arm 74 of the rear left-side assistant steering box 72, which is itself connected to the left steering arm 128 of the second rear axle 106′ by a tie rod 76.

On the right side of the truck 100 (see FIG. 5), the pitman arm 140 of the first rear right-side assistant box 68 is linked by tie rod 78 to the right steering arm 120 of the first rear axle 106. Similarly, the pitman arm 142 of the second rear right-side 1o assistant box 70 is linked by tie rod 79 to the right steering arm 122 of the second rear axle 106′. Transversal tie rods 130 and 130′ are provided to connect the idle arms on opposite sides of axles 106 and 106′, respectively.

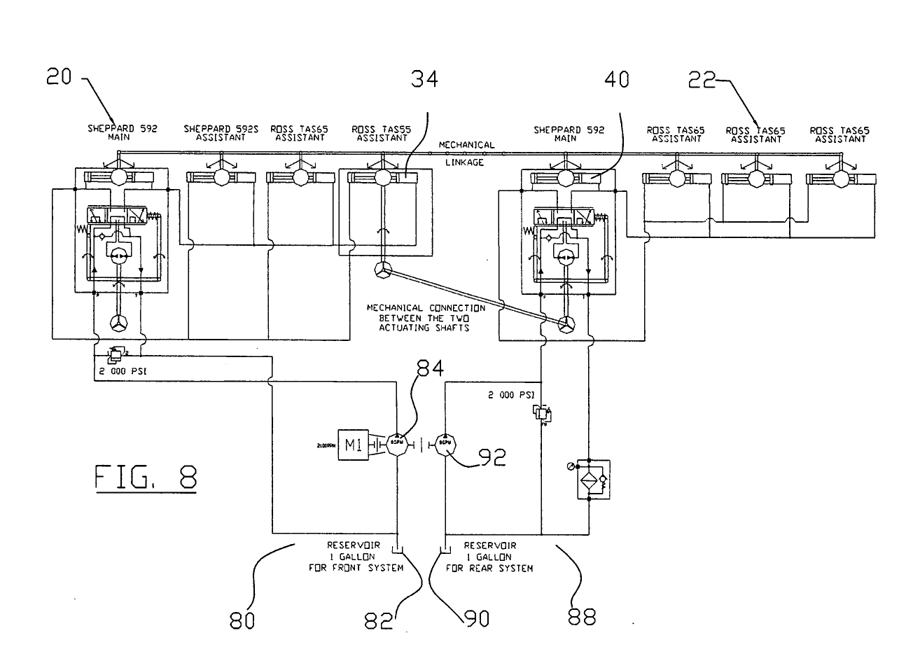

One advantage of the present invention is that it allows the rear steering system to have its own hydraulic control independent from the one of the front steering system. In this respect, FIG. 8, shows an exemplary embodiment of a hydraulic system for operating the steering systems and the linkage assembly described above.

As may be seen in both FIGS. 2A and 8, the steering arrangement of the present invention preferably includes a front hydraulic pressure system 80 which is responsive to the load on the front wheels of said vehicle, as well known in the art. The front hydraulic pressure system 80 provides the necessary hydraulic pressure signal to all of the steering gears of the front steering system 20 and to the front linkage gear mechanism 34 of the mechanical linkage assembly, if it is hydraulically assisted. It preferably includes a hydraulic tank 82 providing the oil and a hydraulic pump 84 pumping this oil to provide the hydraulic pressure signal. As mentioned above, the front linkage gear mechanism 34 is preferably provided with a hydraulic power flow assisting the rotation of its shaft upon pivoting movement of its pitman arm.

A rear hydraulic pressure system 88, responsive to the load on the rear wheels of the vehicle, is also provided. The rear hydraulic pressure system 88 provides a hydraulic pressure signal to the rear steering system 22 of the vehicle, including the rear linkage gear mechanism 40 of the mechanical linkage assembly if it is also hydraulically assisted. The rear hydraulic pressure system 88 also includes a hydraulic tank 90 and a hydraulic pump 92.

As mentioned above, the present invention may advantageously be used to adapt a vehicle having a pre-existing front steering system but lacking means to steer its rear wheels. According to another aspect of the present invention, there is therefore also provided a method for providing a multiple-axle vehicle with a common steering of its front and rear wheels. It is understood that the vehicle already has a front steering system steering the front wheels and responsive to a steering signal from the operator of the vehicle. The method includes the following steps:

a) providing the vehicle with a rear steering system steering its rear wheels;

b) providing the vehicle with a mechanical linkage assembly as described above, and therefore including a front and a rear linkage gear mechanisms both having a rotatable shaft and a pivotable arm, and mechanical connecting means operationally connecting these rotatable shafts;

c) operationally connecting the pivotable arm of the front linkage gear mechanism to the front steering system for receiving the steering signal therefrom; and

d) operationally connecting the pivotable arm of the rear linkage gear mechanism to the rear steering system for transmitting the steering signal thereto.

Preferably, the following additional steps are also provided:

e) connecting the front linkage gear mechanism to a front hydraulic pressure system of the vehicle; and

f) providing a rear hydraulic pressure system responsive to a load on the rear wheels of the vehicle, and connecting it to the rear steering system and to the rear linkage gear mechanism of the mechanical linkage assembly.

It is understood that the above steps may be carried out in any appropriate order. In summary, according to the present invention, there is provided a mechanical linkage assembly for a multiple-axle vehicle, this vehicle having both front and rear wheels steering systems, the linkage assembly including a front linkage gear mechanism connected to the front wheels steering system and transforming the steering movement therefrom into a rotation movement, a rear linkage gear mechanism connected to the rear wheels steering system and transforming this rotation movement into a rear wheels steering movement, and a shaft or other connecting element of assembly connecting the front and rear linkage gear mechanisms to transmit the rotation movement therebetween. Independent hydraulic control of the front and rear steering gears may also advantageously be provided.

It will be understood that as a result of the present invention, it is the driver of the vehicle who gives the signal for simultaneously turning the front and rear wheels.

It should be noted that the linkage assembly may be used to link any number of front and rear axles together.

The model and the capacity of the boxes may be different depending on the vehicle. Computations must be carried out to determine the required capacity.

Of course, numerous modifications could be made to the embodiment described above without departing from the scope of the present invention as defined in the appended claims.

1. A mechanical linkage assembly for a multiple-axle vehicle having a front and a rear steering system for respectively steering front and rear wheels of said vehicle, the front steering system being responsive to a steering signal from an operator of said vehicle, the mechanical linkage assembly comprising:
a front linkage gear mechanism having a rotatable shaft. a pivotable arm operationally connected to the front steering system for receiving the steering signal therefrom, and a gear arrangement transforming a pivoting of said pivotable arm into a rotation of said rotatable shaft;
a rear linkage gear mechanism having a rotatable shaft, a pivotable arm operationally connected to the rear steering system for transmitting the steering signal thereto and a gear arrangement transforming a rotation of said rotatable shaft into a pivoting of said pivotable arm; and
mechanical connecting means operationally connecting the rotatable shafts of the front and rear linkage gear mechanisms.

2. The mechanical linkage assembly according to claim 1, wherein said mechanical connecting means comprise a connecting shaft having opposite ends respectively connected to the rotatable shafts of the front and rear linkage gear mechanisms.

3. The mechanical linkage assembly according to claim 1, wherein the front and rear linkage gear mechanisms respectively include a front and a rear steering gear each having a steering shaft defining the corresponding rotatable shaft, and a pitman arm defining the corresponding pivotable arm.

4. The mechanical linkage assembly according to claim 3, wherein the front steering gear is provided with an hydraulic flow assisting the rotation of the rotatable shaft.

5. The mechanical linkage assembly according to claim 1, further comprising a first tie rod linking the pivotable arm of the front linkage gear mechanism to the front steering system of said vehicle.

6. The mechanical linkage assembly according to claim 5, further comprising a second tie rod linking the pivotable arm of the rear linkage gear mechanism to the rear steering system of said vehicle.

7. A steering arrangement for jointly steering front and rear wheels of a multiple-axle vehicle, comprising:
a front steering system steering said front wheels of the vehicle and responsive to a steering signal from an operator of said vehicle;
a mechanical linkage assembly comprising:
a front linkage gear mechanism having a rotatable shaft, a pivotable arm operationally connected to the front steering system for receiving the steering signal therefrom, and a gear arrangement transforming a pivoting of said pivotable arm into a rotation of said rotatable shaft;
a rear linkage gear mechanism having a rotatable shaft, a pivotable arm and a gear arrangement transforming a rotation of said rotatable shaft into a pivoting of said pivotable arm,; and
mechanical connecting means operationally connecting the rotatable shafts of the front and rear gear mechanisms; and
a rear steering system steering said rear wheels of the vehicle and connected to the pivotable arm of the rear linkage gear mechanism for receiving said steering signal therefrom.

8. The steering arrangement according to claim 7, wherein the front and rear linkage gear mechanisms respectively include a front and a rear steering gear each having a steering shaft defining the corresponding rotatable shaft, and a pitman arm defining the corresponding pivotable arm.

9. The steering arrangement according to claim 8, further comprising a front hydraulic pressure system responsive to a load on the front wheels of said vehicle, said front hydraulic pressure system providing a hydraulic pressure signal to the front steering system of said vehicle and the front steering gear of said mechanical linkage assembly.

10. The steering arrangement according to claim 9, wherein said hydraulic pressure signal from the front hydraulic pressure system flows in the front steering gear so as to assist the rotation of the rotatable shaft thereof.

11. The steering arrangement according to claim 9, further comprising a rear hydraulic pressure system responsive to a load on the rear wheels of said vehicle, said rear hydraulic pressure system providing a hydraulic pressure signal to the rear steering system of said vehicle and to the rear steering gear of said mechanical linkage assembly.

12. The steering arrangement according to claim 9, wherein each of said front and rear hydraulic pressure systems comprises a hydraulic tank providing oil thereto and a hydraulic pump pumping said oil to provide said hydraulic pressure signal.

13. The steering arrangement according to claim 7, wherein said mechanical connecting means comprise a connecting shaft having opposite ends respectively connected to the rotatable shafts of the front and rear linkage gear mechanisms.

14. The steering arrangement according to claim 7, further comprising a first tie rod linking the pivotable arm of the front linkage gear mechanism to the front steering system of said vehicle.

15. The steering arrangement according to claim 14, further comprising a second tie rod linking the pivotable arm of the rear linkage gear mechanism to the rear steering system of said vehicle.

16. A method for providing a multiple-axle vehicle with joint steering of front and rear wheels thereof, said vehicle having a front steering system steering said front wheels and responsive to a steering signal from an operator of said vehicle, the method comprising the steps of:
a) providing said vehicle with a rear steering system steering said rear wheels of the vehicle;
b) providing said vehicle with a mechanical linkage assembly comprising:
a front linkage gear mechanism having a rotatable shaft, a pivotable arm, and a gear arrangement transforming a pivoting of said pivotable arm into a rotation of said rotatable shaft;
a rear linkage gear mechanism having a rotatable shaft, a pivotable arm, and a gear arrangement transforming a rotation of said rotatable shaft into a pivoting of said pivotable arm; and
mechanical connecting means operationally connecting the rotatable shafts of the front and rear linkage gear mechanisms;
c) operationally connecting the pivotable arm of the front linkage gear mechanism to the front steering system for receiving the steering signal therefrom; and
d) operationally connecting the pivotable arm of the rear linkage gear mechanism to the rear steering system for transmitting the steering signal thereto.

17. The method according to claim 16, further comprising a step of connecting the front linkage steering gear to a front hydraulic pressure system of said vehicle.

18. The method according to claim 16, further comprising a step of providing said vehicle with a rear hydraulic pressure system responsive to a load on the rear wheels thereof, and connecting said rear hydraulic pressure system to the rear steering system of said vehicle and to the rear linkage gear mechanism of said mechanical linkage assembly.
